(19) United States
(12) Patent Application Publication
(10) Pub. No.: US 2005/0077112 A1
(43) Pub. Date: Apr. 14, 2005

(54) Lifting device

(76) Inventor: Franz Ehrenleitner, Stuttgart (DE)

Correspondence Address: FACTOR & LAKE, LTD, 1327 W. WASHINGTON BLVD., SUITE 5G/H, CHICAGO, IL, 60607, US

(21) Appl. No.: 10/897,558

(22) Filed: Jul. 23, 2004

(30) Foreign Application Priority Data
Jul. 18, 2003 (DE) 103 32 709.6

(51) Int. Cl. B66C 11/04

(52) U.S. Cl. 187/261

(57) ABSTRACT

A lifting device (1) for lifting and lowering a load comprises a supporting structure (2), which comprises a bottom structure (3) capable of being fastened to a room floor and a top structure (21) connected to the bottom structure (3) and arranged at a vertical distance thereabove. A lifting drum (28) and a drive (30), by which the lifting drum (28) can be set in rotation in both directions, are arranged in the vicinity of the bottom structure (3). At least one flexible traction means (32 to 37) is secured by one end to the lifting drum (28), has a section running from the lifting drum (28) to the top structure (21) and is led over at least one deflection roller (38, 39, 41, 42, 43, 53) rotatably mounted on the top structure (21). At its other end, a holding arrangement (40) for the load is provided. Thus, only those elements which do not normally need any maintenance or repair at all are to be provided on the top structure (21), which is relatively difficult to get at. Elements which may occasionally require maintenance or repair, in particular the lifting drum (28) and the drive (30), are easily accessible in the vicinity of the bottom structure (3).

The invention relates to a lifting device for lifting and lowering a load having
a) a supporting structure, which comprises a bottom structure capable of being fastened to a room floor and a top structure connected to the bottom structure and arranged at a vertical distance thereabove;
b) a lifting drum;
c) a drive, by which the lifting drum can be set in rotation in both directions;
d) at least one flexible traction means, which is secured by one end to the lifting drum and at the other end carries a holding arrangement for the load;
e) it being possible for the flexible traction means to be wound up on and unwound from the lifting drum by rotation of the latter.

Lifting devices which operate with a lifting drum and at least one flexible traction means capable of being wound up on this lifting drum are known in a wide variety of designs. As the traction means, use is made in particular of ropes, chains or bands. In such lifting devices known from the market, the lifting drum and the drive which sets it in rotation are fitted in the region of the top structure. The traction means therefore run essentially only downwards and have, possibly before the downward-running section, a section with a horizontal extending direction. The disadvantage with this is that repairs and maintenance which may occasionally be necessary on the elements susceptible thereto, namely the lifting drum and the drive, are difficult to carry out since these elements are difficult to get at.

The object of the present invention is to design a lifting device of the type mentioned at the beginning in such a way that it is easier to maintain and repair.

This object is achieved according to the invention in that
f) the lifting drum and the drive are arranged in the vicinity of the bottom structure;
g) the traction means comprises a section extending from the lifting drum to the top structure and is led over at least one deflection roller rotatably mounted on the top structure.

In the lifting device according to the invention, those elements which may need maintenance or repair, namely the lifting drum and the drive associated therewith, are therefore arranged in the vicinity of the bottom structure and are easily accessible there. Maintenance and repair work can thus be carried out quickly and conveniently.

A particularly preferred embodiment of the invention is distinguished in that at least two flexible traction means are provided, of which one is led over only one deflection roller on the top structure and the second is led over two deflection rollers on the top structure, between which there is a distance in the horizontal direction. This results in a lifting device with which a relatively large object can be grasped at two places situated at a horizontal distance from one another and thus lifted or lowered.

Preferably, at least one flexible traction means is a band which can be wound up turn upon turn on the lifting drum. Bands have the advantage that they can be wound up on the lifting drum in a particularly well-defined manner and their load-bearing capacity is relatively high, but they remain sufficiently flexible.

The preferred band is a metal band, preferably a steel band.

An exemplary embodiment of the invention is explained in more detail below with reference to the drawing, in which

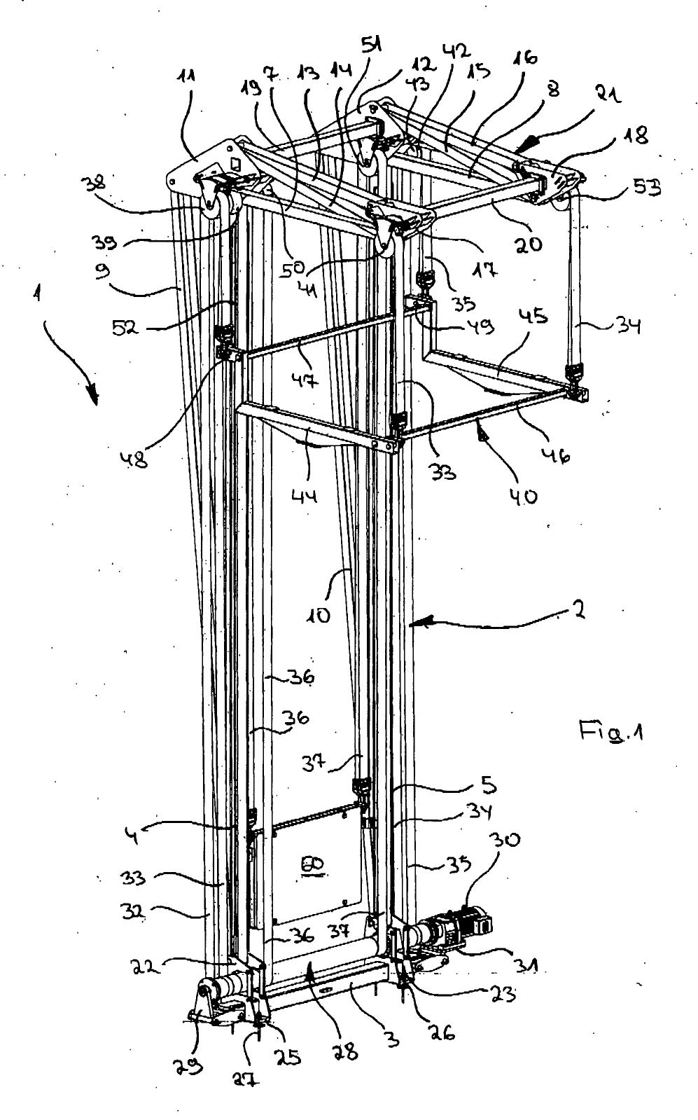

FIG. 1 shows a perspective view of a lifting device according to the invention;

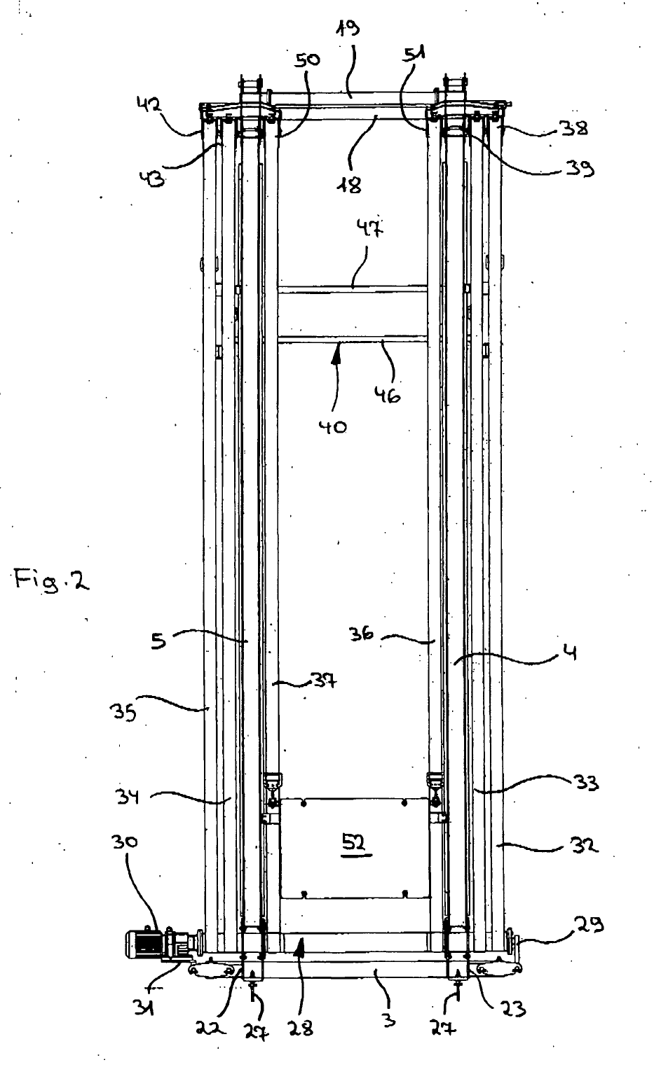

FIG. 2 shows the rear view of the lifting device of FIG. 1;

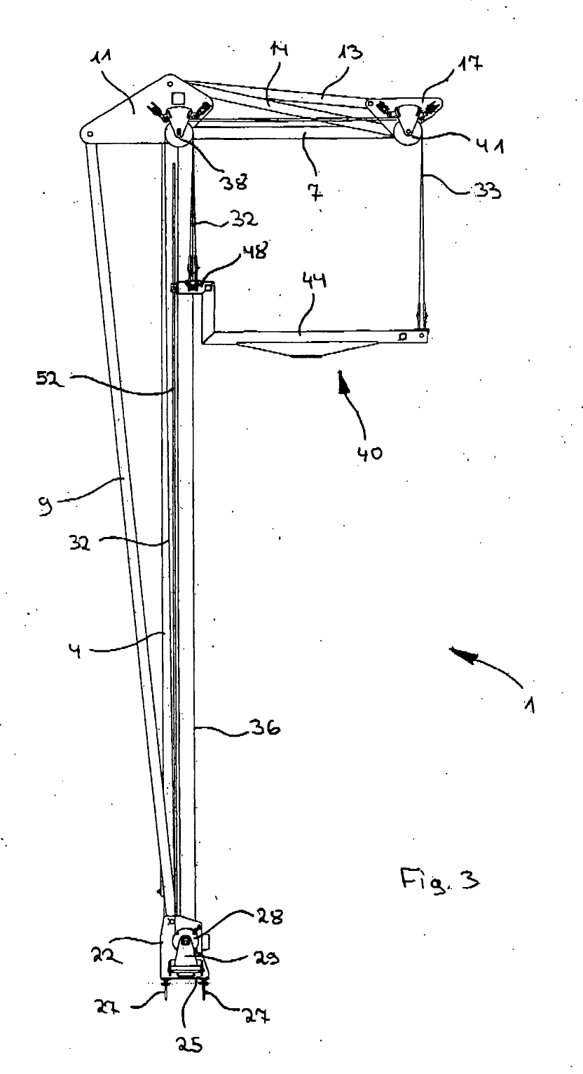

FIG. 3 shows the side view of the lifting device of FIG. 1;

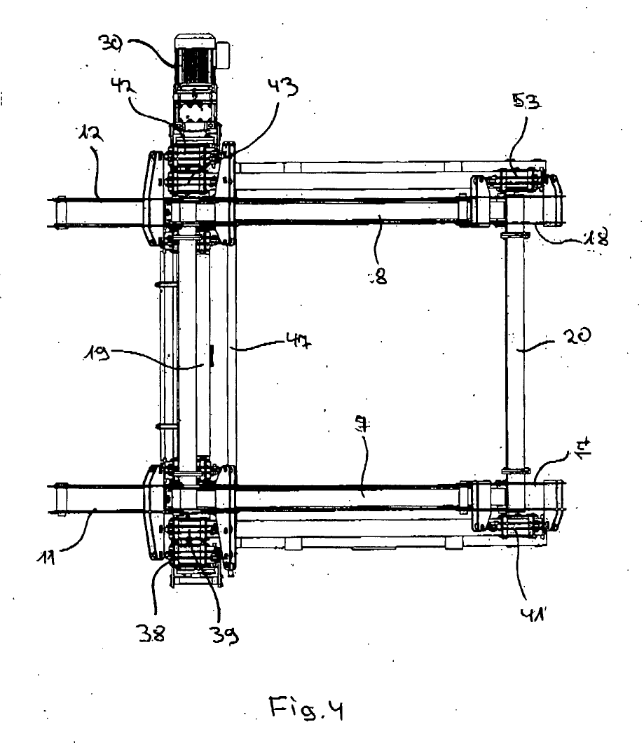

FIG. 4 shows the top view of the lifting device of FIG. 1.

The lifting device, illustrated in the drawing and provided as a whole with the reference symbol 1, serves principally but not exclusively for lifting and lowering heavy loads in industrial manufacturing plants, for example for lifting and lowering vehicle bodies in vehicle manufacture. It comprises a support structure 2, which has a horizontal bottom beam 3 serving as a bottom structure, two vertically running columns 4 and 5, and a top structure 21, which is fastened to the top end of the columns 4 and 5, projects horizontally forwards and has two parallel cantilevers 7 and 8. The support structure 2 is strengthened in the manner of a framework by braces 9, 10, which run obliquely upwards from the bottom beam 3 to a connecting structure 11, 12, which comprises two plates and protrudes somewhat rearwards.

The connecting structures 11, 12 also protrude somewhat upwards beyond the cantilevers 7, 8. Obliquely running braces 13, 14 and 15, 16 extend from the top region of the rear connecting structures 11, 12 to further connecting structures 17, 18, attached to the front ends of the cantilevers 7, 8. The rear connecting structures 11, 12 are connected to one another by a horizontal beam 19 and the front connecting structures 17, 18 are connected to one another by a horizontal beam 20. Altogether, the cantilevers 7, 8 and the beams 19, 20 form, with the aid of the connecting structures 11, 12, 17, 18 and the stiffening braces 13, 14, 15, 16, the stable top structure 21, which is arranged at a distance above the room floor.

The horizontal bottom beam 3 is connected to the columns 4 and 5 via bottom connecting structures 22, 23, which have flanges 25, 26 resting on the room floor. The entire support structure 2 can be fastened to the room floor by screws 27 passed through the flanges 25, 26.

Above and parallel to the bottom beam 3, a lifting drum 8 extends through the bottom connecting structures 22. It is rotatably mounted, at the left end in FIG. 1, in a bearing pedestal 29, which, for its part, is fastened to the bottom beam 3. The opposite end, on the right in FIG. 1, of the lifting drum 28 is frictionally connected to a gear motor 30, which, for its part, is arranged on a mounting plate 31 connected to the bottom beam 3. The lifting drum 28 can be rotated in both directions of rotation by the gear motor 30.

A total of six metal bands 32, 33, 34, 35, 36, 37, serving as flexible traction means, can, by rotation, be wound up on and unwound from the lifting drum 28 to a greater or lesser extent and in different axial positions.

Two of these bands 32, 33 can be wound up on that axial region of the lifting drum 28 which projects towards the left beyond the left bottom connecting structure 22 in FIG. 1. They run substantially vertically upwards to two deflection rollers 38, 39, which are rotatably mounted independently of one another on the rear, outer end of the cantilever 7. The outermost band 32 extends from the associated deflection roller 38 downwards again and is fastened to the rear region, on the left in FIG. 1, of a lifting frame 40, which is described in detail hereinbelow. The band 33, which is adjacent to the band 32 but runs closer to the column 4, is led over the deflection roller 39, extends from the latter horizontally and parallel to the cantilever 7 and runs over a further deflection roller 41, rotatably mounted at the front end of the cantilever 7. From there, the band 33 extends downwards again until it is fastened by its end to the front corner region, on the left in FIG. 1, of the lifting frame 40.

In a corresponding, substantially mirror-symmetrical manner, the bands 34, 35 are mounted in that axial region of the lifting drum 28 which protrudes towards the right beyond the right bottom connecting structure 23 in FIG. 1. The outermost band 35 leads upwards to a deflection roller 42, which is difficult to see in FIG. 1, and from there downwards again and is secured by its end to the rear corner region, on the right in FIG. 1, of the lifting frame 40. The band 34 running between the band 35 and the right column 5 is led upwards to a deflection roller 43, runs from there substantially horizontally to a deflection roller 53 mounted at the front end of the cantilever 8, from their downwards again and is fastened by its end to the front corner region, on the right in FIG. 1, of the lifting frame 40. The arrangement is thus such that the lifting frame 40 is held substantially horizontally by the four bands 32, 33, 34, 35, it being possible to alter the height at which the lifting frame 40 is situated in each case, by rotating the lifting drum 28 by means of the gear motor 30.

The lifting frame 40 itself comprises two substantially L-shaped side parts 44, 45, which are arranged in such a position that the longer legs of the L each run horizontally and the shorter legs each run vertically. The front ends of the side parts 44, 45 are connected to one another by a horizontal brace 46 and the upper ends of the vertical, short legs of the side parts 44, 45 are connected to one another by a further horizontal brace 47. From the top ends of the vertical legs of the side parts 44, 45, short guiding projections 48, 49 additionally extend rearwards and are provided, on their inner side, with guiding rollers, not visible in the drawing. These guiding rollers engage in slots 52, which are formed in the outer sides of the columns 4, 5 and extend substantially over their entire length.

In that axial region of the lifting drum 28 which lies between the bottom connecting structures 22, 23, and respectively adjacent to these structures, two further bands 36, 37 can be wound up. This takes place however in the opposite direction of rotation to that of the outer bands 32, 33, 34, 35 which hold the lifting platform 40. The bands 36, 37 extend from the lifting drum 28 upwards to respective deflection rollers 50 and 51, which are rotatably mounted on the inner sides of the rear ends of the cantilevers 7, 8. From there, the bands 36, 37 run downwards again. Their ends are secured to the opposite ends of the top edge of a plate-shaped counterweight 60.

The above-described lifting device 1 works as follows:

The object to be lifted or lowered is suitably fastened to the lifting frame 40. In FIG. 1, this lifting frame 40 is situated at a relatively great height. If it is to be lowered from this position, the lifting drum 28 is rotated, with the aid of the gear motor, in such a way that the stock of the bands 32, 33, 34, 35 wound up on the protruding axial regions of the lifting drum 28 is partly unwound. As a result, the length of the bands 32, 33, 34, 35 between the lifting drum 28 and the lifting frame 40 gets longer; the lifting frame 40 descends correspondingly, while being vertically guided by the engagement, in the slots 52 of the columns 4, 5, of the guiding rollers fastened to the guiding projections 48, 49.

Simultaneously, the bands 36, 37 are wound up on the lifting drum 28 owing to their reverse winding direction, whereby the balancing weight 60 is correspondingly lifted.

The only elements which are occasionally in need of maintenance or repair in practice are the gear motor 30 and possibly the lifting drum 28. Owing to the arrangement of these elements in the vicinity of the bottom beam 3, they are easily accessible at any time, so that the relevant work can be carried out without any problems.

1. Lifting device for lifting and lowering a load, the lifting device comprising:
a) a supporting structure, having a bottom structure capable of being fastened to a room floor and a top structure connected to the bottom structure and arranged at a vertical distance thereabove;
b) a lifting drum;
c) a drive, by which the lifting drum can be set in rotation in both directions;
d) at least one flexible traction means, which is secured by one end to the lifting drum and at the other end carries a holding arrangement for the load;
e) the flexible traction means being capable of being wound up on and unwound from the lifting drum by rotation of the latter;
wherein
f) the lifting drum and the drive are arranged in the vicinity of the bottom structure;
g) the traction means comprises a section extending from the lifting drum to the top structure and is led over at least one deflection roller rotatably mounted on the top structure.

2. Lifting device according to claim 1, wherein the at least one flexible traction means comprises at least two flexible traction means, of which one is led over only one deflection roller on the top structure and the second is led over two deflection rollers on the top structure, between which there is a distance in the horizontal direction.

3. Lifting device according to claim 1, wherein at least one flexible traction means is a band which can be wound up turn upon turn on the lifting drums.

4. Lifting device according to claim 3, wherein the band is a metal band.

5. Lifting device according to claim 4, wherein the band is a steel band.
